(19) United States
(12) Patent Application Publication
(10) Pub. No.: US 2024/0289606 A1
(43) Pub. Date: Aug. 29, 2024

(54) SYSTEMS AND METHODS FOR AN ENCODER-DECODER BASED FRAMEWORK FOR CODE GENERATION AND UNDERSTANDING

(71) Applicant: Salesforce, Inc., San Francisco, CA (US)

(72) Inventors: Yue Wang, Singapore (SG); Hung Le, Singapore (SG); Akhilesh Deepak Gotmare, Singapore (SG); Junnan Li, Singapore (SG); Chu Hong Hoi, Singapore (SG)

(21) Appl. No.: 18/174,547

(22) Filed: Feb. 24, 2023

(51) Int. Cl. G06N 3/08

(52) U.S. Cl. CPC G06N 3/08

(57) ABSTRACT

Embodiments described herein provide a mixture of encoder-decoder Transformer framework for multi-task pretraining and flexible finetuning for both code understanding and generation tasks. Specifically, the framework is built on multimodal encoder and decoder modules. During pre-training, the encoder-decoder framework is trained with multiple learning objectives, including a diverse set of self-supervised tasks over two major stages of pretraining on unimodal and bimodal data.

### CROSS REFERENCE(S)

The instant application is related to co-pending and commonly-owned U.S. nonprovisional application Ser. No. 17/459,968, filed Aug. 27, 2021, which is hereby expressly incorporated herein by reference in its entirety.

### TECHNICAL FIELD

The embodiments relate generally to machine learning systems for code related tasks, and more specifically to an encoder-decoder based Transformer network for code generation and understanding.

### BACKGROUND

Machine learning systems have been widely used in a plurality of natural language processing tasks and/or code-related tasks. For example, large language models (LLMs) have been adopted to pretrain on source code data for various downstream tasks in the code domain such as code generation and understanding tasks. By pretraining large language models (LLMs) on massive code-based data (e.g., GitHub public data), these LLMs can learn rich contextual representations which can be transferred to related downstream code-related tasks. However, existing models are often designed to perform well only in a subset of tasks (e.g., generative-only tasks or understanding-only tasks). For example, encoder-only models are often used to implement understanding tasks such as text-to-code retrieval. For generative tasks such as code generation, decoder-only models are often used.

Therefore, there is a need for a code generation framework adaptable to multiple types of code-related tasks.

### BRIEF DESCRIPTION OF THE DRAWINGS

FIG. 1 is a simplified diagram illustrating an overview of an encoder-decoder pretraining framework comprising two pretraining stages for code generation and understanding, according to some embodiments.

FIG. 2 is a simplified diagram illustrating an example aspect of stage 1 unimodal pretraining on code-only data, according to one or more embodiments described herein.

FIG. 3A is a simplified diagram illustrating an example aspect of stage 2 bimodal pretraining on text-code pair data, according to one or more embodiments described herein.

FIG. 3B is a simplified diagram illustrating an example structure of the encoder-decoder model in an alternative embodiment, according to one or more embodiments described herein.

FIG. 4 is a simplified block diagram illustrating inference or finetuning stage of the encoder-decoder model pretrained via the pretraining stages illustrated in FIGS. 1-3, according to one or more embodiments.

FIG. 5 is a simplified block diagram illustrating a unified retrieval-augmented generation paradigm, according to one or more embodiments described herein.

FIG. 6 is a simplified diagram illustrating a computing device implementing the encoder-decoder model described in FIGS. 1-3B, according to one embodiment described herein.

FIG. 7 is a simplified block diagram of a networked system suitable for implementing the encoder-decoder based code understanding and generation framework described in FIGS. 1-6 and other embodiments described herein.

FIG. 8 is an example logic flow diagram illustrating a method of training an encoder-decoder based framework for code related tasks based on the framework shown in FIGS. 1-7, according to some embodiments described herein.

FIGS. 9-14 provide example data tables showing data experiment results of the encoder-decoder pretraining framework described in FIGS. 1-8, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Existing large language models (LLMs) have been adopted to pretrain on source code data for various downstream tasks in the code domain such as code generation and understanding tasks. Such existing LLMs often adopt a specific architecture that is limited to encoder-only or decoder-only for different downstream tasks, or rely on a single network for all code-related tasks. Performance of the encoder-only or decoder-only paradigm is largely limited by inflexibility in applications of different downstream tasks. But the single-network-for-all paradigm requires finetuning and activating a large set of all model parameters, rendering the training process time and resource consuming.

In view of the need to provide a flexible framework for both code generation and understanding, embodiments described herein provide a mixture of encoder-decoder Transformer framework for multi-task pretraining and flexible finetuning for both code understanding and generation tasks. Specifically, the framework is built on multimodal encoder and decoder modules. During pre-training, the encoder-decoder framework is trained with multiple learning objectives, including a diverse set of self-supervised tasks over two major stages of pretraining on unimodal and bimodal data. For example, a stage-wise pretraining strategy is adopted to first train the encoder-decoder framework on code-only data with span denoising and causal language modeling (CLM) tasks. Then at the second training stage, the encoder-decoder framework is trained on text-code data with cross-modal contrastive learning, matching, and CLM tasks.

In one embodiment, the encoder-decoder framework comprises a mixture of encoder-decoder Transformers. For example, the encoder has multiple encoder submodules operated in parallel and share the same parameters. The decoder may have multiple decoder submodules operated in parallel and share the same parameters except for the last feed forward layers (FFN) that act as a decoder head adapted for different decoding tasks.

In one embodiment, a weight sharing strategy may be adopted through task-specific experts, i.e., experts are designed for different learning tasks while receiving the same backbone contextual representations. In this way, to optimize multi-task learning while efficiently activating the right model parameters, the expert may share parameters from the trained encoder-decoder framework with the feed forward decoder heads for specific learning tasks. In the encoder-decoder Transformer structure, only one feed forward layer expert is activated for each task.

Embodiments described herein provide a number of benefits. For example, component modules can be decoupled/combined based on different training or application tasks, e.g., an adaptation as a unified retrieval-augmented generation system. In this way, the encoder-decoder framework may be adapted for a variety of downstream tasks and functionalities.

### Overview

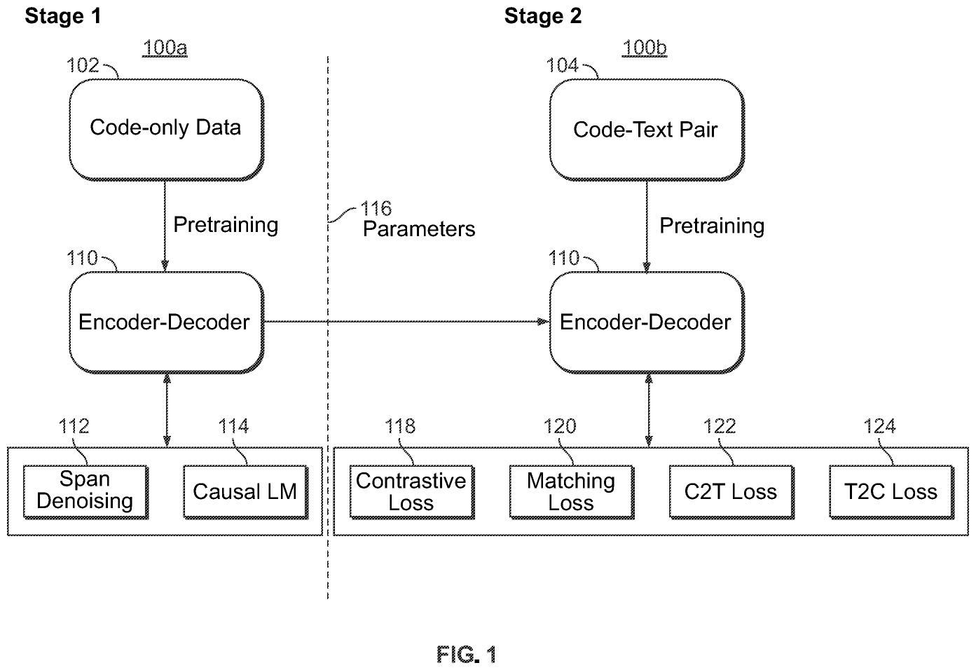

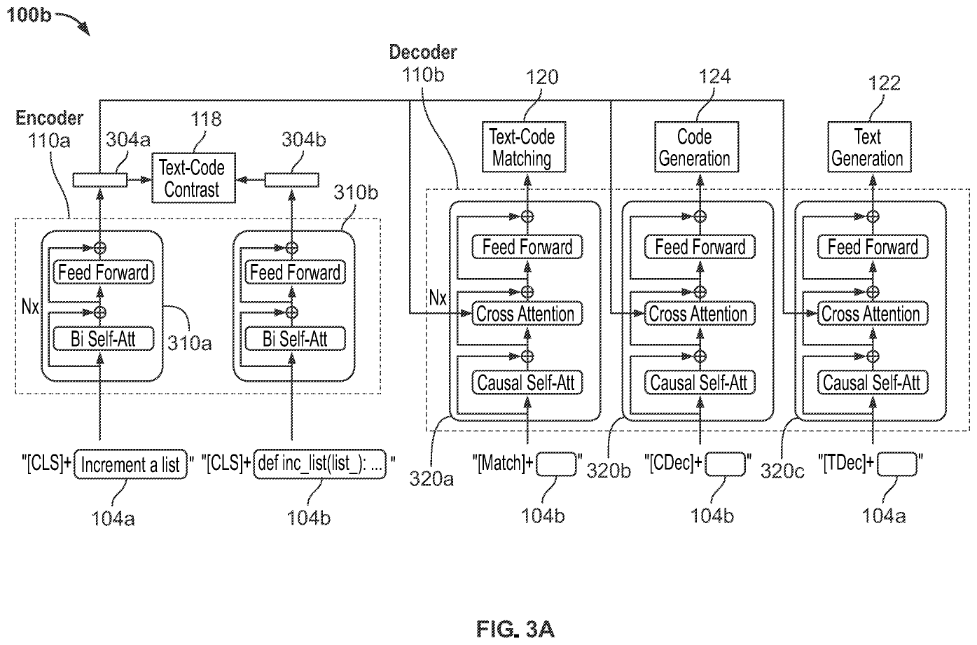

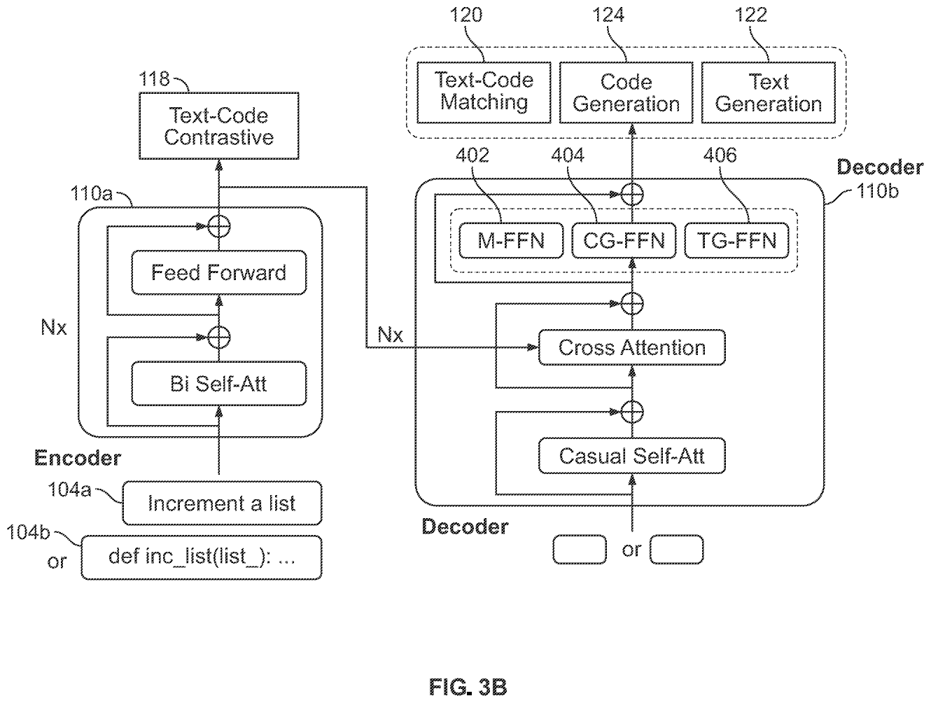

FIG. 1 is a simplified diagram illustrating an overview of an encoder-decoder pretraining framework comprising two pretraining stages 100a and 100b for code generation and understanding, according to some embodiments. An encoder-decoder model 110 is employed, comprising multiple Transformers-based encoders and decoders. Each of the Transformer-based encoder or decoder can operate a specific functionality and in combination, the combination of which serve as a unified multi-task encoder-decoder model 110. Additional details of the architecture of encoder-decoder 110 may be discussed in relation to FIGS. 3A-3B.

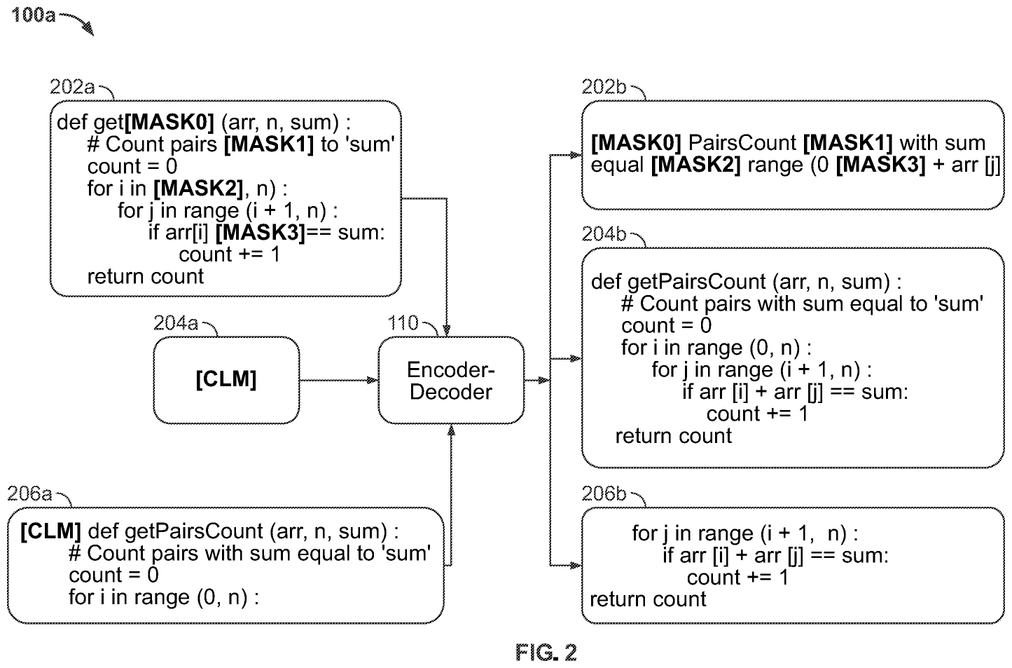

In one embodiment, the encoder-decoder model 110 may be trained according to a set of self-supervised tasks over two pretraining stages: unimodal pretraining (stage 1 110a) and bimodal pretraining (stage 2 100b). In the first stage 100a of unimodal pretraining, a vanilla encoder-decoder Transformer model 110 is pretrained with massive code-only data 102 using computationally efficient objectives, such as span denoising loss 112 and casual language modeling loss 114. Further details of stage 1 pretraining 110a are discussed below in relation to FIG. 2.

In the second stage 100b of bimodal pretraining, the encoder-decoder model 110 inherits previously trained encoder-decoder parameters 116 from the first stage 110a and acts as a backbone to initialize the mixture encoder-decoder Transformers. The encoder-decoder Transformer model 110 is then trained with a smaller set of code-text data 104 with cross-modal learning objectives, such as a text-code contrastive loss 118, a text-code matching loss 120, a code-to-text generation loss 122 and a text-to-code generation loss 124. Further details of stage 2 pretraining 110b are discussed below in relation to FIGS. 3A-3B.

In this way, the stage-wise training approach 100a-b efficiently expose the encoder-decoder model 110 to more diverse data and thus to learn rich contextual representations of code and texts. For each stage, multiple pretraining objectives (e.g., 112 and 114 in stage 1 110a; and 118, 120, 122 and 124 in stage 2 100b) may be jointly optimized with equal weights.

FIG. 2 is a simplified diagram illustrating an example aspect of stage 1 unimodal pretraining on code-only data, according to one or more embodiments described herein. As shown in FIG. 2, during stage 1 pretraining 100a, the encoder-decode model 110 is pretrained on large-scale code-only unimodal data 102 shown in FIG. 1. Code-only unimodal data 102 can often be obtained from opensource platforms like GitHub. The encoder-decoder model 110 is pretrained from scratch (e.g., from a vanilla encoder-decoder model) using a mixture of span denoising and causal language modeling (CLM) tasks.

In one embodiment, the encoder input 202a and the decoding output 202b show an example of span denoising training. For example, a portion of a code-only input (e.g., 15% of its tokens) may be randomly replaced by indexed sentinel tokens (like [MASKO]). The training input with [MASKO], similar to code input 202a, may be encoded by the encoder of model 110 into a code representation. The decoder of model 110 is then configured to recover the original unmasked code input, by generating a combination of the spans that have been randomly replaced. An example decoding output may be shown at 202b. A span denoising loss 112 (shown in FIG. 1) may then be computed by comparing the output spans 202b with the originally unreplaced spans in the code input, e.g., a cross-entropy loss.

In one embodiment, the training input 202a may be generated with whole-word masking by sampling spans before subword tokenization to avoid masking partial subtokens.

In one embodiment, the encoder input 206a and the decoding output 206b show an example of one variant of CLM training to optimize the encoder-decoder model 110 for auto-regressive generation. For example, a pivot location may be randomly selected within a code-only input. In one implementation, the pivot location is to be uniformly sampled between 10% and 90% of the whole code-only sequence.

In this way, context before the pivot location may be treated as the source sequence and the sequence after the pivot location may be treated as the target output. The encoder input 206a may comprise a special token [CLM] prepended to the source sequence and encoded by the encoder of model 110 into a code representation. The decoder of model 110 then generate a predicted code sequence 206b next to the source sequence. A CLM loss (114 in FIG. 1) may then be computed by comparing the predicted code sequence 206b and the target sequence, e.g., a cross-entropy loss.

In one embodiment, the encoder input 204a and the decoding output 204b show an example of another variant of CLM training. Specifically, the second CLM variant is a decoder-only generation task and can be viewed as an extreme case of the first variant. A single [CLM] token is passed as the encoder input 204a, and thus only the decoder is needed to generate the full code sequence 204b based on the encoded representation of [CLS]. A CLM loss (114 in FIG. 1) for this variant is computed similarly as in the first variant. Compared to the first variant shown by the encoder input 206a and decoder output 206b, this task aims to provide more dense supervision signals to train the decoder as an independent full-fledged code generation module.

In one embodiment, by combining the span denoising task and the CLM task, the encoder-decoder model 110 may be updated based on a sum of the span denoising loss 112 and the CLM loss 114 via backpropagation. In this way, the encoder-decoder model 110 learns to recover code contexts at different scales: code spans, partial programs, and complete programs.

FIG. 3A is a simplified diagram illustrating an example aspect of stage 2 bimodal pretraining 100b on text-code pair data, according to one or more embodiments described herein. FIG. 3A shows an example architecture in which the encoder and decoder components are initialized from the resulting checkpoints from the first pretraining stage 100a. The encoder-decoder architecture comprises an encoder 110a and a decoder 110b.

Specifically, the encoder 110a may comprise one or more (e.g., two, etc.) bimodal encoder submodules 310a and 310b operated in parallel. These bimodal encoder submodules 310a-b may be identical and share the same parameters.

In the second stage 100b, text-code bimodal data (e.g., 104 in FIG. 1) comprising text-code pairs are used to pretrain the encoder-decoder model 110 with weights/parameters pretrained from the first stage 100a. Each text-code pair comprises a code function 104b and its corresponding docstring 104a describing its semantics. Such a bimodal data format facilitates the exploration of model training for cross-modal understanding and generation.

In one embodiment, the bimodal encoder 310a receives and encodes a text input 104a into a continuous text representation through bidirectional self-attention and a feed forward layer processing. Similar to BERT, a special token [CLS] is prepended to the text input and the output embedding at the final Transformer layer of the bimodal encoder 310a as the representations 304a of the corresponding input text. A linear layer is added to map the output representation to 256-dimensional vectors together with the L2 normalization as the text representation 304a.

In parallel to the bimodal encoder 310a, the bimodal encoder 310b receives and encodes a code snippet input 104b into a continuous code representation through bidirectional self-attention and a feed forward layer processing. Similar to BERT, a special token [CLS] is prepended to the code input and the output embedding at the final Transformer layer of the bimodal encoder 310b as the representations of the corresponding input text. A linear layer is added to map the output representation to 256-dimensional vectors together with the L2 normalization as the code representation 304b.

In one embodiment, the text representation 304a and the code representation 304b may be used to compute a text-code contrastive loss 118. Specifically, the text-code contrastive learning task aligns the feature space of text and code encoder by pulling together the representations of positive text-code pairs and pulling apart the negative pairs. This task only activates the bimodal encoders 310a-b to produce the text/code embedding/representations 304a-b. For example, given a text sample T 104a and a code sample C 104b, representations ht 304a for text T and hc 304b for code C are generated as described above, e.g., by mapping the [CLS] embeddings to normalized lower-dimensional (256-d) representations from the bimodal encoders 310a-b.

Given a batch of N text-code pairs, text vectors {h^{t}}ᵢ₌₁^{N} 304a and code vectors {h^{c}}ᵢ₌₁^{N} 304b are obtained from the bimodal encoders 310a-b to compute text-to-code and code-to-text and similarities:

$${s}_{i , j}^{t2c} = {h}_{i}^{t} ⊤ {h}_{j}^{c} , {s}_{i , j}^{c2t} = {h}_{i}^{c} ⊤ {h}_{j}^{t} \qquad ( 1 )$$

$${p}_{i}^{t2c} ( T ) = \frac{exp ( {s}_{i , j}^{t2c} / τ )}{{\sum }_{j = 1}^{N} exp ( {s}_{i , j}^{t2c} / τ )} , {p}_{i}^{c2t} ( C ) = \frac{exp ( {s}_{i , j}^{c2t} / τ )}{{\sum }_{j = 1}^{N} exp ( {s}_{i , j}^{c2t} / τ )} \qquad ( 2 )$$

where s_{i,j}^{t2c} represents text-to-code similarity for text of i-th pair and code of j-th pair, s_{i,j}^{c2t} is the code-to-text similarity, and t is learned temperature parameter. pᵢ^{t2c}(T) and pᵢ^{c2t}(C) are the softmax-normalized text-to-code and code-to-text similarities for the i-th text and code. Let y^{t2c}(T) and y^{c2t}(C) denote the ground-truth one-hot similarity, where negative pairs have a probability of 0 and the positive pair has a probability of 1. The text-code contrastive loss 118 from a corpus D of text-code pairs (e.g., 104 in FIG. 1) may then be computed as the cross-entropy H between p and y:

$${ℒ}_{lcc} = \frac{1}{2} {𝔼}_{( T , C ) ∼ D} [ H ( {y}^{t2c} ( T ) , {p}^{t2c} ( T ) ) + H ( {y}^{c2t} ( C ) , {p}^{c2t} ( C ) ) ] \qquad ( 3 )$$

In one embodiment, to enrich the negative samples, a momentum encoder may be adopted in addition to the bimodal encoders 310a-b, to store embeddings of samples 104a-b from previous mini-batches. Specifically, the momentum encoder maintains a queuing system that enqueues the samples in the current mini-batch and dequeues the samples in the oldest mini-batch. To ensure the consistency of representations across training steps, the momentum encoder may be updated by linear interpolation of the original encoder and the momentum encoder. Besides, since text and code samples might be loosely paired and each text/code sample can have multiple positive pairs, the momentum encoder to create soft labels and consider the potential positives in the negative pairs. Additional details of momentum encoders may be found in Li et al., 2022, co-pending and commonly-owned U.S. nonprovisional application Ser. No. 17/745,540, which is hereby expressly incorporated by reference herein by its entirety.

At the decoder side, the decoder 110b may comprise one or more (e.g., two, three, four, and/or the like) decoder submodules 320a-d operated in parallel. These decoder submodules may be different decoders according to different training tasks, e.g., a bimodal matching decoder 320a for the text-code matching task, a unimodal generation decoder 320a or 320c for generation tasks. The decoder submodules 320a-c may share similar structures and similar parameters except for the last feed forward layer, which acts as a respective decoder head adapted to generate a respective decoder output according to the specific training task.

In one embodiment, the bimodal matching decoder 320a may predict whether a text 104a and code snippet 104b share the same semantics according to a text-code matching (TCM) task. This task activates the bimodal matching decoder and aims to learn better bimodal representations that capture the fine-grained alignment between text and code modalities.

Specifically, given a code sample 104b, a task-specific [Match] token is prepended to the code input sequence 104b to inform the decoder 320a of the text-code matching functionality, and a [EOS] token is appended to the end of the code input 104b. The bimodal matching decoder 320a first passes the prepended code snippet to an embedding layer and a causal self-attention layer. The self-attention representations are then passed to a cross-attention layer which queries relevant signals from the text representations 304a (received from the bimodal encoder 310a). The output embedding of [EOS] at the last decoder layer is used as the text-code cross-modal alignment representation, as the decoder 320a employs causal self-attention masks and only the last decoder token can attend to all the contexts.

A linear layer is built on top of the output embedding of the decoder 320a for a binary classification task, which predicts whether a text-code pair is positive (matched) or negative (unmatched). The output embedding of the [EOS] token is used as the fused bimodal representation for a text-code pair (T, C). Followed by a linear layer and softmax, a two-class probability p^{tcm} (T) may be computed, and thus the TCM loss 120 may be computed as:

[symbol]

_{tcm}= [symbol] (T,C)˜D[H(y^{tcm}(T,C),p^{tcm}(T,C))] (4)

where y^{tcm} (T, C) is a 2-dimensional one-hot vector representing the ground-truth label. In order to find more informative negatives, a hard negative mining strategy may be adopted. Specifically, hard negatives are sampled based on the contrastive-based similarity scores between the current sample and previous samples in the queue maintained by the momentum encoder. As such, harder negatives are more likely to be selected. For a batch of positive pairs, two batches of negative pairs are constructed by mining negatives from the text/code queue with a code/text query. Additional details of hard negative mining may be found in co-pending and commonly-owned U.S. nonprovisional application Ser. No. 17/370,524, filed Jul. 8, 2021, which is hereby expressly incorporated by reference herein in its entirety.

In parallel to the bimodal matching decoder 320a, the unimodal generation decoders 320b-c may be used for training with text-code dual generation tasks. The generation tasks focus on a cross-modal generative objective between text and code through a dual multimodal conversion: text-to-code generation and code-to-text generation (i.e. code summarization). Each conversion separately activates the corresponding (unimodal) code/text generation decoder 320b or 320c. This task may close the gap between the pretraining and finetuning stage on generation-based bimodal application tasks, e.g., using text-to-code generation.

Specifically, unimodal generation decoders 320b-c may generate an output sequence in programming language/natural language. These decoders follow the same design as the bimodal matching decoder 310a with causal attention and cross-attention layers. When the input is a text sample 104a to the encoder, a code generation decoder is used and the code snippet 104b is prepend with a [CDec] token as the first token in the input sequence to the decoder 320b. The code generation decoder 320b operates in code generation functionality to generate a predicted code sequence corresponding to the text input 104a. The predicted code sequence is then compared with the code sequence 104b to compute a text-to-code generation loss 124 L_{t2c}, e.g., a cross-entropy loss.

When the input is a code sample 104b to the encoder, a text generation decoder 320c is used and a [TDec] token is prepended to the text sample 104a as the input sequence to the decoder 320c. The text generation decoder 320c operates in text generation (i.e. code summarization) functionality to generate a predicted text corresponding to the code input 104b. The predicted text is then compared with the text sequence 104a to compute a code-to-text generation loss 122 L_{c2t}, e.g., a cross-entropy loss.

In this way, the full second-stage pretraining loss may be the sum of losses:

$$ℒ = {ℒ}_{tcc} + {ℒ}_{tcm} + {ℒ}_{t2c} + {ℒ}_{c2t} \qquad ( 5 )$$

The second-stage pretraining loss may then be used to jointly update the encoder 110a and the decoder 310b via backpropagation.

In one embodiment, when only a single encoder within encoder 110a is used to process bimodal data, a partial sharing scheme is adopted among the three decoders 320a-c. Specifically, among the decoders, the parameters of the self-attention and cross-attention layers are shared. Sharing the contextual representations in these layers across text-code matching decoder 320a and text-code dual generation decoders 320b-c may enable cross-task generalization at the context level. In this way, these multimodal training tasks benefit from sharing contextual representations, e.g., a text-to-code generation decoder 320b may benefit from semantic-aware code representations jointly learned from the text-code matching task.

FIG. 3B is a simplified diagram illustrating an example structure of the encoder-decoder model 110 in an alternative embodiment, according to one or more embodiments described herein. The mixture architecture of CodeT5Mix can be interpreted from another view as a unified encoder-decoder with task-specific FFN experts in a shared decoder, which is illustrated in FIG. 3B. Note that while the extra parameter cost of two FFN layers might be introduced compared to a standard encoder-decoder model during pretraining, only one FFN layer is activated when finetuning on one specific downstream task, thereby incurring no additional computational cost.

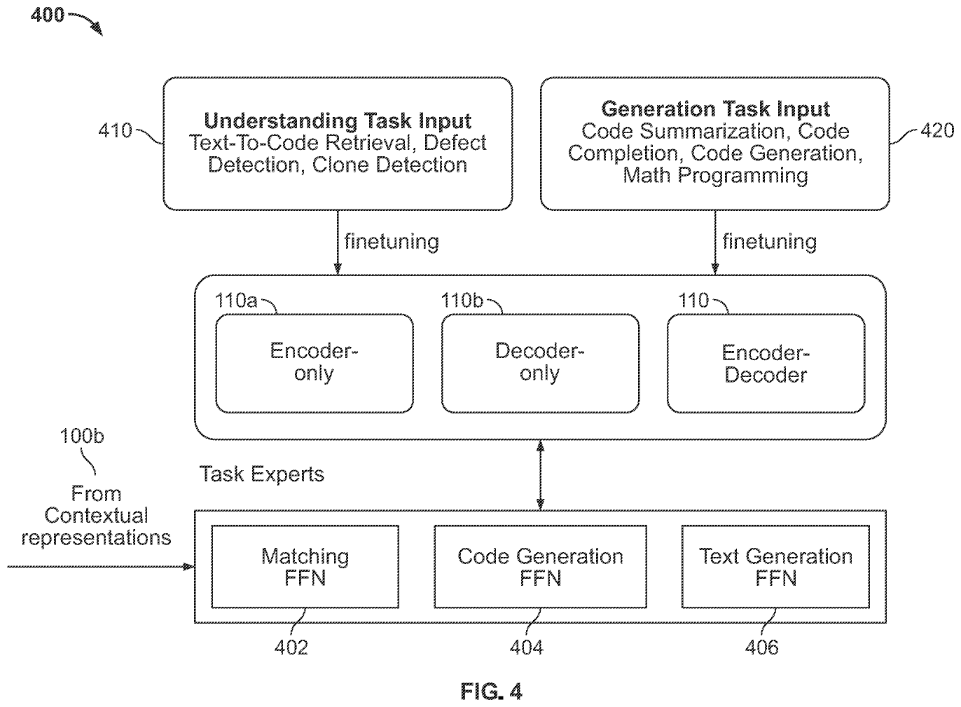

FIG. 4 is a simplified block diagram illustrating inference or finetuning stage 400 of the encoder-decoder model pretrained via the pretraining stages illustrated in FIGS. 1-3, according to one or more embodiments. At inference or finetuning stage 400, depending on the type of downstream tasks, the pretrained encoder-only model 110a, decoder-only model 110b or the encoder-decoder model 110 may be chosen to perform a specific downstream task.

For example, for understanding tasks such as text-to-code retrieval, defect detection, clone detection, and/or the like, the understanding task input 420 may be passed to the pretrained bimodal encoder 110a to obtain text/code embeddings, which can be either passed to a binary classifier for detection tasks or retrieval tasks. Additionally, the pretrained text-code matching decoder 110b (e.g., activating 320b in FIG. 3A) may be added to predict the matching probabilities.

For another example, for decoder-only tasks, a [CLM] token is prepended to the encoder input and pass the source sequence to the decoder as the prefix context. Then the weights of the encoder 110a are frozen and the cross-attention layers at the decoder 110b to reduce the number of trainable parameters.

For another example, for generation tasks such as code summarization, code completion, code generation, mathematical programming, and/or the like, the task-specific expert may be selected based on the output modality.

In one embodiment, while sharing contextual representations across tasks, feed-forward layers (FFN) 402, 404 and 406 with separate weights may be deployed. Specifically, the FFN layers 402-406 act as task-specific experts in the encoder-decode model 110 to reduce cross-task interference. For example, the matching FFN 402, code generation FFN 404, or text generation FFN 406 may each act as a task expert to receive contextual representations from the pretrained decoder 110b in FIG. 3A and share with among the decoders according to the specific task.

Another benefit of this sharing approach is to efficiently activate the right model parameters for different application tasks while keeping the model sizes affordable. Note that a weight-sharing scheme that fully shares all parameters among the decoders can save more parameter costs, but will result in serious interference and performance drops in downstream tasks. Moreover, the extra parameter cost of the task experts can be waived during finetuning, as only a single task expert (e.g., FFN 402, 404 or 406 according to the task) will be activated for one downstream task and thus, incur no extra computational cost.

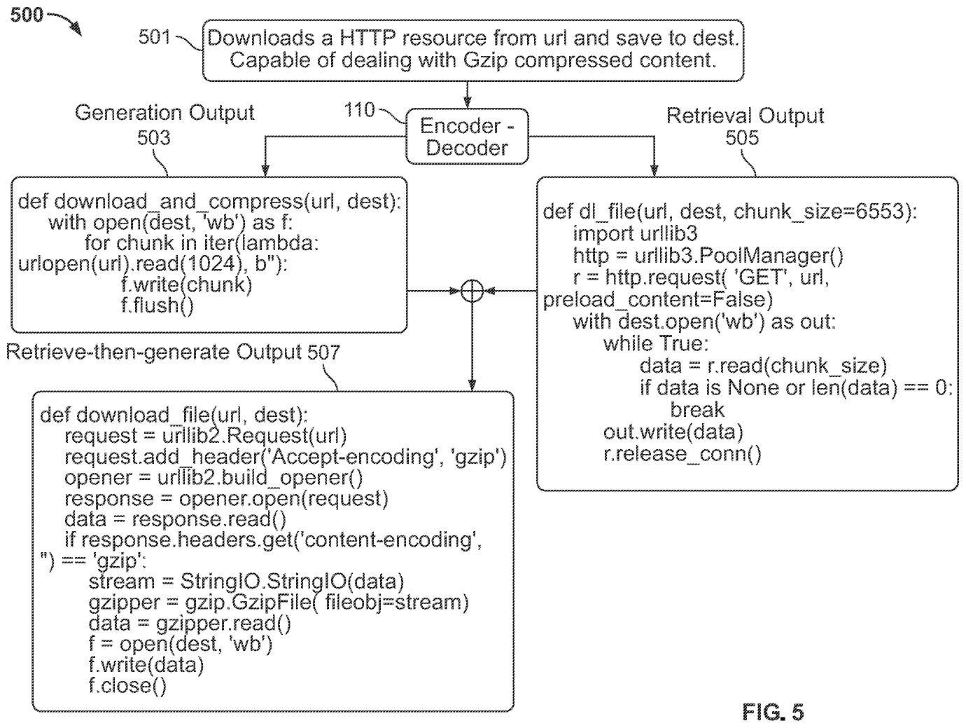

FIG. 5 is a simplified block diagram illustrating a unified retrieval-augmented generation paradigm 500, according to one or more embodiments described herein. Paradigm 500 shows using the pretrained encoder-decoder model 110 for both code retrieval and generation, and then aggregating the result as a unified semiparametric retrieval-augmented generator. For example, a text input 501 is passed to the encoder-decoder model 110, which provides a generation output 503 according to a code generation task, and a retrieval output 505 according to a retrieval task. The retrieved code 505 provides crucial contexts (e.g., use “urllib3” for an HTTP request) to guide the generative process for more correct prediction resulting in the retrieve-then-generate output 507. In contrast, the generative task gives an incorrect prediction, e.g., the generate-only code 503 only captures the concepts of “download” and “compress”.

### Computer and Network Environment

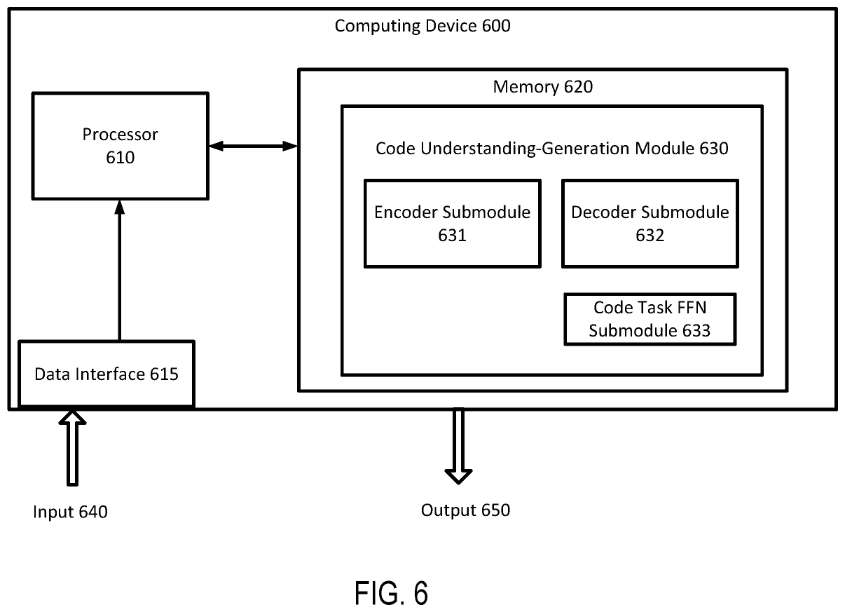

FIG. 6 is a simplified diagram illustrating a computing device implementing the encoder-decoder model 110 described in FIGS. 1-3B, according to one embodiment described herein. As shown in FIG. 6, computing device 600 includes a processor 610 coupled to memory 620. Operation of computing device 600 is controlled by processor 610. And although computing device 600 is shown with only one processor 610, it is understood that processor 610 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 600 may be implemented as a stand-alone subsystem, as a board added to a computing device, and/or as a virtual machine.

Memory 620 may be used to store software executed by computing device 600 and/or one or more data structures used during operation of computing device 600. Memory 620 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 610 and/or memory 620 may be arranged in any suitable physical arrangement. In some embodiments, processor 610 and/or memory 620 may be implemented on a same board, in a same package (e.g., system-in-package), on a same chip (e.g., system-on-chip), and/or the like. In some embodiments, processor 610 and/or memory 620 may include distributed, virtualized, and/or containerized computing resources. Consistent with such embodiments, processor 610 and/or memory 620 may be located in one or more data centers and/or cloud computing facilities.

In some examples, memory 620 may include non-transitory, tangible, machine readable media that includes executable code that when run by one or more processors (e.g., processor 610) may cause the one or more processors to perform the methods described in further detail herein. For example, as shown, memory 620 includes instructions for code understanding and generation module 630 that may be used to implement and/or emulate the systems and models, and/or to implement any of the methods described further herein. code understanding and generation module 630 may receive input 640 such as an input training data (e.g., code-only data 102 or code-text pairs 104) via the data interface 615 and generate an output 650 which may be a code or text output. Examples of the input data may include a code-only input sample. Examples of the output data may include a text output that explains the code input sample according to a code understanding task.

The data interface 615 may comprise a communication interface, a user interface (such as a voice input interface, a graphical user interface, and/or the like). For example, the computing device 600 may receive the input 640 (such as a training dataset) from a networked database via a communication interface. Or the computing device 600 may receive the input 640, such as a code sample or a text sample, from a user via the user interface.

In some embodiments, the code understanding and generation module 630 is configured to generate a code or text output according to a specific code-related task, such as code generation, code summarization, code retrieval, code understanding, and/or the like. The code understanding and generation module 630 may further include an encoder submodule 631 (e.g., similar to 110a in FIG. 3A), a decoded submodule (e.g., similar to 110b in FIG. 3A) and code task FFN submodules 633 (e.g., similar to FFNs 402, 404, 406 in FIG. 4). In one implementation, the code task FFN submodules 633 may be part of the decoder submodule 632, as shown in FIG. 3B.

In one embodiment, the code understanding and generation module 630 and its submodules 631-633 may be implemented by hardware, software and/or a combination thereof.

In one embodiment, the code understanding and generation module 630 and one or more of its submodules 631 may be implemented via an artificial neural network. The neural network comprises a computing system that is built on a collection of connected units or nodes, referred as neurons. Each neuron receives an input signal and then generates an output by a non-linear transformation of the input signal. Neurons are often connected by edges, and an adjustable weight is often associated to the edge. The neurons are often aggregated into layers such that different layers may perform different transformations on the respective input and output transformed input data onto the next layer. Therefore, the neural network may be stored at memory 620 as a structure of layers of neurons, and parameters describing the non-linear transformation at each neuron and the weights associated with edges connecting the neurons. An example neural network may be a Transformer network, and/or the like.

In one embodiment, the neural network based code understanding and generation module 630 and one or more of its submodules 631-633 may be trained by updating the underlying parameters of the neural network based on the loss described in relation to FIGS. 1-3B. For example, the loss described in Eq. (5) is a metric that evaluates how far away a neural network model generates a predicted output value from its target output value (also referred to as the “ground-truth” value). Given the loss computed according to Eq. (5), the negative gradient of the loss function is computed with respect to each weight of each layer individually. Such negative gradient is computed one layer at a time, iteratively backward from the last layer to the input layer of the neural network. Parameters of the neural network are updated backwardly from the last layer to the input layer (backpropagating) based on the computed negative gradient to minimize the loss. The backpropagation from the last layer to the input layer may be conducted for a number of training samples in a number of training epochs. In this way, parameters of the neural network may be updated in a direction to result in a lesser or minimized loss, indicating the neural network has been trained to generate a predicted output value closer to the target output value.

Some examples of computing devices, such as computing device 600 may include non-transitory, tangible, machine readable media that include executable code that when run by one or more processors (e.g., processor 610) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

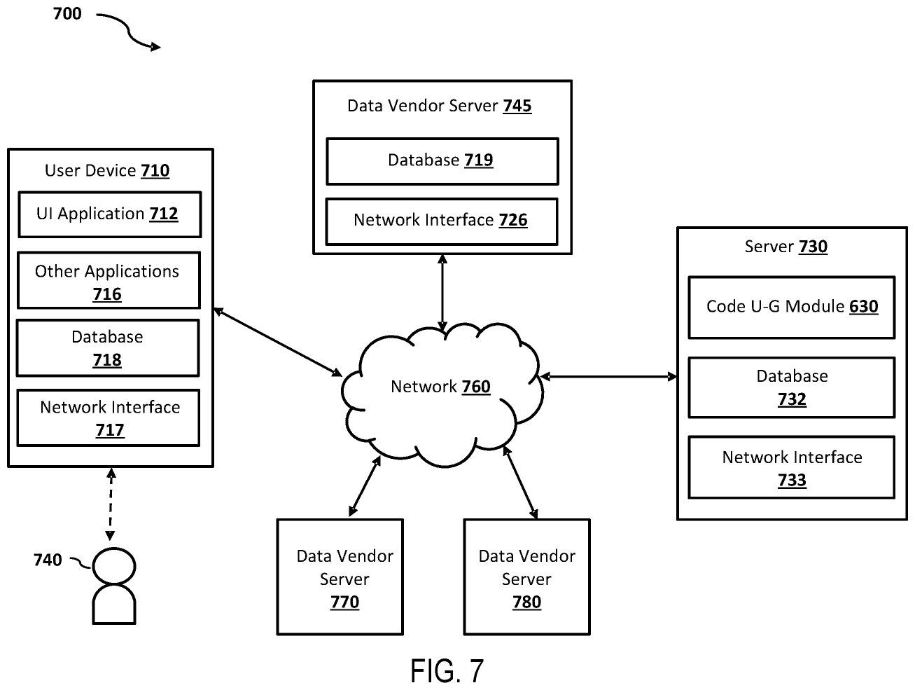

FIG. 7 is a simplified block diagram of a networked system 700 suitable for implementing the encoder-decoder based code understanding and generation framework described in FIGS. 1-6 and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 600 described in FIG. 6, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating the code or text output from the server 730 and display the message via the UI application 712. In other embodiments, user device 710 may include additional or different modules having specialized hardware and/or software as required.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view the generated code or text output according to a specific code-related task.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including unimodal code-only data 102 and bimodal code-text pairs 104 to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the code understanding and generation module 630 and its submodules described in FIG. 6. In some implementations, code understanding and generation module 630 may receive data from database 719 at the data vendor server 745 via the network 760 to generate a code snippet or text description. The generated code snippet or text description may also be sent to the user device 710 for review by the user 740 via the network 760.

The database 732 may be stored in a transitory and/or non-transitory memory of the server 730. In one implementation, the database 732 may store data obtained from the data vendor server 745. In one implementation, the database 732 may store parameters of the code understanding and generation module 630. In one implementation, the database 732 may store previously generated code snippets or text description, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Work Flows

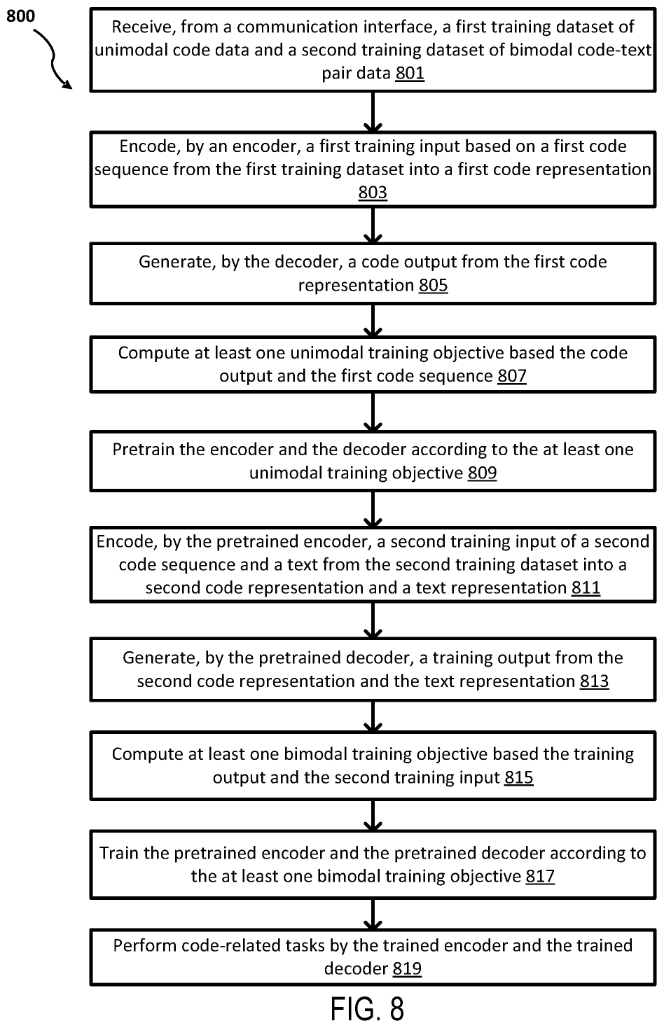

FIG. 8 is an example logic flow diagram illustrating a method of training an encoder-decoder based framework for code related tasks based on the framework shown in FIGS. 1-7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the code understanding and generation module 630 (e.g., FIGS. 6-7) that performs training of the encoder-decoder based framework for code related tasks.

As illustrated, the method 800 includes a number of enumerated steps, but aspects of the method 800 may include additional steps before, after, and in between the enumerated steps. In some aspects, one or more of the enumerated steps may be omitted or performed in a different order.

At step 801, a first training dataset of unimodal code data and a second training dataset of bimodal code-text pair data may be received via a communication interface may be received via a communication interface (e.g., data interface 615 in FIG. 6, network interface 733 in FIG. 0.7).

At step 803, an encoder (e.g., 110a in FIG. 3A) may encode a first training input based on a first code sequence from the first training dataset into a first code representation. For example, the first training input is generated by randomly replacing a portion of tokens in the first code sequence into indexed sentinel tokens. For another example, the first training input is generated by randomly selecting a pivot location in the first code sequence, and then truncating a first portion of the first code sequence before the pivot location as the first training input.

At step 805, a decoder (e.g., 110b in FIG. 3A) may generate a code output from the first code representation.

At step 807, at least one unimodal training objective is computed based the code output and the first code sequence. For example, the at least one unimodal training objective is computed by comparing a reconstructed code sequence by the decoder with the first code sequence. For another example, the at least one unimodal training objective is computed by comparing a predicted remaining portion of code by the decoder with a second portion of the first code sequence after the pivot location

At step 809, the encoder and the decoder may be jointly trained according to the at least one unimodal training objective.

At step 811, the pretrained encoder may encode a second training input of a second code sequence and a text from the second training dataset into a second code representation and a text representation. For example, the encoder comprises a first encoder module and a second encoder module that share same parameters and operate in parallel. The first encoder module encodes the text into the text representation, and the second encoder module encodes the second code sequence into the second code representation in parallel.

At step 813, the pretrained decoder may generate a training output from the second code representation and the text representation. For example, the decoder comprises one or more decoder modules that share same parameters except a last feed forward layer adapted as a different decoder head for different bimodal training objectives. The one or more decoder modules may generate respective decoding outputs according to the different bimodal training objectives in parallel.

At step 815, at least one bimodal training objective may be computed based the training output and the second training input. For example, the at least one bimodal training objective is computed as a contrastive loss based on a batch of code-text pairs from the second training dataset. The encoder generates a set of code representations and a set of text representations from the batch of code-text pairs. A set of code-to-text similarities and a set of text-to-code similarities are computed between the set of code representations and the set of text representations, e.g., Eqs. (1)-(2). The contrastive loss is computed by comparing the set of code-to-text similarities and the set of text-to-code similarities with ground-truth one-hot similarities, e.g., Eq. (3).

For another example, the at least one bimodal training objective is computed as a text-code matching loss. A classification head of the decoder may generate a prediction on whether the second code sequence and the text is a matching pair. A matching loss by comparing the prediction and a ground-truth one-hot label corresponding to the second code sequence and the text, e.g., Eq. (4).

For another example, the at least one bimodal training objective is computed as a text-to-code generation loss. The decoder may generate a predicted code sequence based on the text representation. A text-to-code generation loss is computed by comparing the predicted code sequence and the second code sequence.

For another example, the at least one bimodal training objective is computed as a code-to-text generation loss. The decoder may generate a predicted text based on the second code representation. A code-to-text generation loss is computed by comparing the predicted text and the text.

At step 817, the pretrained encoder and the pretrained decoder are trained (again) according to the at least one bimodal training objective. For example, the pretrained encoder and the pretrained decoder may be trained according to a sum of multiple bimodal training objectives, e.g., Eq. (5).

At step 819, the trained encoder and decoder model may perform code-related tasks, such as code summarization, code generation, code retrieval, code-text alignment, and/or the like. For example, depending on the type of code-related task, the encoder-only model, decoder-only model, or the encoder-decoder model may be selected to perform the code-related task.

### Example Data Experiments

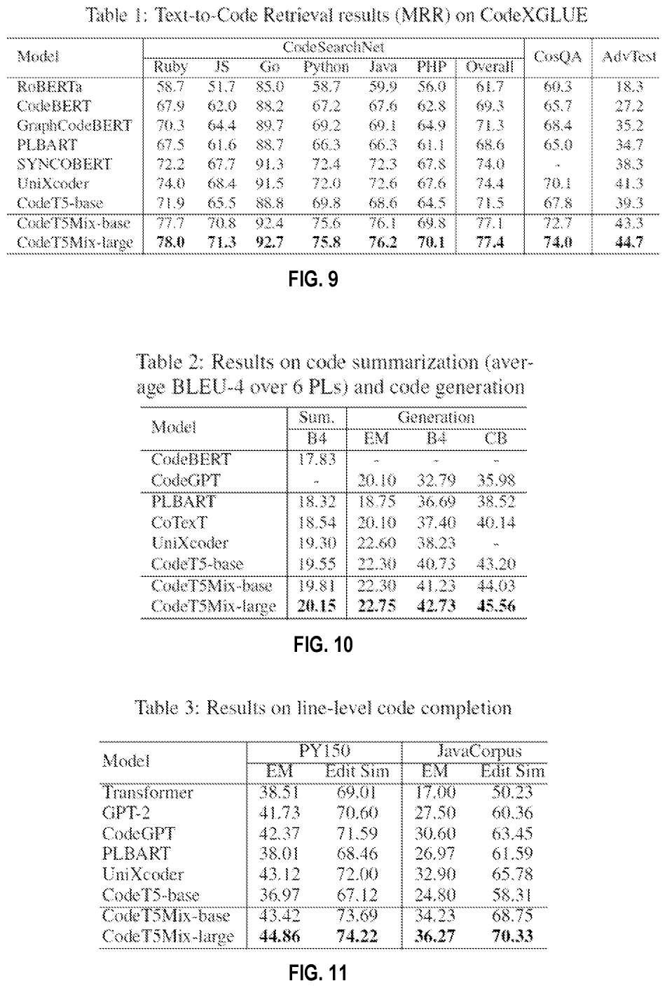

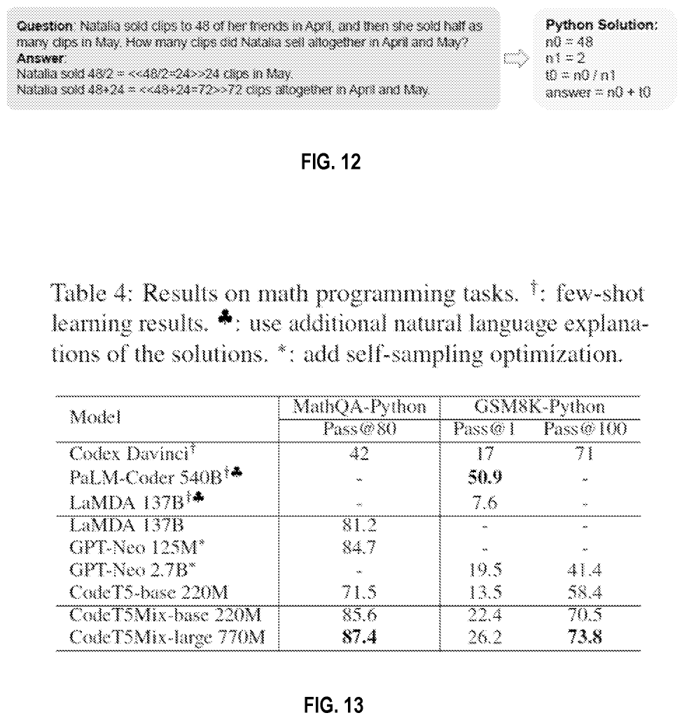

FIGS. 9-14 provide example data tables showing data experiment results of the encoder-decoder pretraining framework described in FIGS. 1-8, according to embodiments described herein.

Comprehensive experiments have been conducted on a wide range of code understanding and generation tasks across nine programming languages (PLs). Checkpoints from the 1st-stage pretraining for code completion and math programming tasks due to the gap of their task or data domain with 2nd-stage bimodal pretraining. Two variants of the encoder-decoder model 110 are adopted: base (220M) and large (770M) models. The encoder-decoder model 110 (referred to as “CodeT5Mix” in the data experiments) is compared with code-based pretrained LMs. For encoder-only models, ROBERTa (Liu et al., A robustly optimized BERT pretraining approach, in Computing Research Repository (CoRR), abs/1907.11692, 2019), CodeBERT (Feng et al., Codebert: A pre-trained model for programming and natural languages, In proceedings of Empirical Methods in Natural Language Processing (EMNLP), pp. 1536-1547, 2020) trained with masked language modeling, GraphCodeBERT (Guo et al., GraphCodeBERT: Pre-training code representations with data flow, In proceedings of International Conference and Learning Representations (ICLR), OpenReview.net, 2021) using data flow extracted from abstract syntax tree (AST) of code, and SYNCOBERT (Wang et al., Syncobert: Syntax-guided multi-modal contrastive pre-training for code representation, arXiv preprint arXiv:2108.04556, 2021) that incorporates AST and contrastive learning are considered. For decoder-only models, GPT-2 (Radford et al., Language models are unsupervised multitask learners, OpenAI blog, 1(8):9, 2019) and CodeGPT (Lu et al., Codexglue: A machine learning benchmark dataset for code understanding and generation, In proceedings of NeurIPS Datasets and Benchmarks, 2021) are considered, where both are pretrained using a CLM objective. For encoder-decoder models, PLBART (Ahmad et al., Unified pre-training for program understanding and generation, In proceedings of North American Chapter of the Association for Computational Linguistics (NAACL-HLT), pp. 2655-2668, 2021) and CodeT5 (U.S. Nonprovisional application Ser. No. 17/459,968) that employ a unified framework to support both understanding and generation tasks are considered. CodeT5-large results from co-pending and commonly-owned U.S. nonprovisional application Ser. No. 17/896,942, filed Aug. 26, 2022 is also compared.

Additionally, another unified model UniXcoder (Guo et al., Unixcoder: Unified cross-modal pre-training for code representation, In proceedings of Association for Computational Linguistics (ACL), pp. 7212-7225, 2022) that employs UniLM-style masking (Dong et al., Unified language model pre-training for natural language understanding and generation, In proceedings of NeurIPS 2019, pp. 13042-13054, 2019) is considered. Models such as CodeBERT, GraphCodeBERT, SYNCOBERT, UniXcoder are based on ROBERTa-base with 125M parameters, while GPT-2/CodeGPT has 124M and PLBART has 140M. Notably, CodeT5Mix uses only half of its full size when operating in encoder-only and decoder-only modes.

The task of text-to-code retrieval aims to find the most semantically related code snippet at the function level from a collection of candidate codes based on a natural language query. Three datasets are adopted for evaluation: CodeSearchNet (Husain et al., CodeSearch Net challenge: Evaluating the state of semantic code search, CoRR, abs/1909.09436, 2019), CosQA (Huang et al., CosQA: 20, 000+ web queries for code search and question answering. In ACL/IJCNLP (1), pp. 5690-5700, Association for Computational Linguistics, 2021), and AdvTest (Lu et al.), which are curated from the original CodeSearchNet by filtering data with low-quality queries, adopting real-world queries from a modern search engine, and obfuscating identifiers to normalize the code. In this task, the bimodal encoder is activated and matching decoder of CodeT5Mix and use Mean Reciprocal Rank (MRR) as the metric.

As shown in Table 1 of FIG. 9, CodeT5Mix-base significantly outperforms all existing encoder-only and encoder-decoder models and the large variant further sets new SoTA results, surpassing the previous SoTA UniXcoder by more than 3 absolute MRR points on all 3 tasks across 8 datasets. This implies CodeT5Mix is a robust code retriever model to handle queries with diverse formats and PLs. Besides, CodeT5Mixbase yields substantial performance gains over CodeT5-base, which can be attributed to the text-code contrastive learning and matching objectives that facilitate better unimodal and bimodal representation learning. Particularly, compared to SYNCOBERT and UniXcoder pretrained with contrastive learning, the proposed models achieve much better results, which can be attributed to bimodal matching decoder that allows for more fine-grained text-code alignments.

The decoder-only generation capability of CodeT5Mix is tested through a line-level code completion task, which aims to complete the next whole line code based on the previous code contexts. PY150 (Raychev et al., Probabilistic model for code with decision trees. In proceedings of Object-Oriented Programming Systems, Languages, and Applications (OOPSLA), pp. 731-747, 2016) and GitHub JavaCorpus (Allamanis et al., Mining source code repositories at massive scale using language modeling, in proceedings of Mining Software Repositories (MSR), pp. 207-216, IEEE Computer Society, 2013) from CodeXGLUE, and use exact match (EM) accuracy and Levenshtein edit similarity (Svyatkovskiy et al., Intellicode compose: code generation using transformer, In proceedings of ESEC/SIGSOFT FSE, pp. 1433-1443, 2020) as evaluation metrics. Typically, this task requires a decoder-only model for efficient training.

As shown in Table 3 of FIG. 11, CodeT5Mix achieves new SoTA results compared to both decoder-only and encoder-decoder models in both metrics. In particular, CodeT5Mix-base yields substantial improvements over CodeT5-base by 6.45 and 9.43 EM scores on PY150 and JavaCorpus respectively. This is mainly due to our CLM objectives in the first-stage pretraining, which allows the decoder to see longer sequences instead of a combination of discrete spans in CodeT5, leading to a better causal generation capability.

The task of code summarization aims to summarize a code snippet into docstrings while code generation is to produce a function based on a natural language description. The clean version of CodeSearchNet dataset in six PLs for code summarization and a Java ConCode (Iyer et al., Mapping language to code in programmatic context, In proceedings of EMNLP, pp. 1643-1652, 2018) for code generation. For evaluation metric, BLEU-4 (B4) is employed, exact match (EM) accuracy, and CodeBLEU (CB) (Ren et al., CodeBLEU: a method for automatic evaluation of code synthesis, CoRR, abs/2009.10297, 2020) which accounts for syntactic and semantic matches based on the code structure in addition to the n-gram match.

From CodeT5Mix, the bimodal encoder and the text generation decoder are activated for code summarization, and with the code generation decoder for code generation. From Table 2 of FIG. 10, encoder-decoder models (CodeT5 and CodeT5Mix) generally outperform both encoder-only and decoder-only models, as well as the unified UniXcoder with controlled masks on both tasks. This implies that encoder-decoder models can better support.

For seq2Seq generation tasks, CodeT5Mix-large achieves new SoTA results on both tasks across various metrics. To evaluate models for code generation, exact match or BLEU scores might be limited as there can be multiple forms of correct program solutions. Two math programming tasks, namely MathQA-Python (Austin et al., Program synthesis with large language models, arXiv preprint arXiv:2108.07732, 2021) and GSM8K (Cobbe et al., Training verifiers to solve math word problems, CoRR, abs/2110.14168, 2021), where code correctness can be measured based on the execution outputs of code programs. The task is to generate Python programs to solve mathematical problems described in natural language descriptions. The solutions in GSM8K are converted into Python programs (henceforth GSM8K-Python), where one example is illustrated in FIG. 13.

Pass@k is employed, which measures the percentage of problems solved using k generated programs per problem. Apart from CodeT5, CodeT5Mix is compared with very large-scale decoder-only models including Codex (Chen et al., Evaluating large language models trained on code, arXiv preprint arXiv:2107.03374, 2021), LaMDA (Austin et al., Program synthesis with large language models. arXiv preprint arXiv:2108.07732, 2021), PaLM-Coder (Chowdhery et al., PALM: Scaling language modeling with pathways, CoRR, abs/2204.02311, 2022), and GPT-Neo (Black et al., Gpt-NEO: Large scale autoregressive language modeling with mesh-tensorflow, March 2021, URL https://doi.org/10.5281/zenodo, 5297715) with self-sampling optimization (Ni et al., Learning from self-sampled correct and partially-correct programs, CoRR, abs/2205.14318, 2022). As shown in Table 4 of FIG. 13, CodeT5Mix achieves significant performance gains, outperforming many pretrained models of much larger sizes. Specifically, CodeT5Mix-large achieves new SoTA results of 87.4 pass@80 on MathQA-Python and 73.8 pass@100 on GSM8K-Python. On GSM8K-Python, the encoder-decoder model achieves the second-best result of 26.2 pass@1, only behind PaLM-Coder with a much larger size (at 540B) than CodeT5Mix. This model was also exposed to much larger pretraining data and used additional explanations of the solutions.

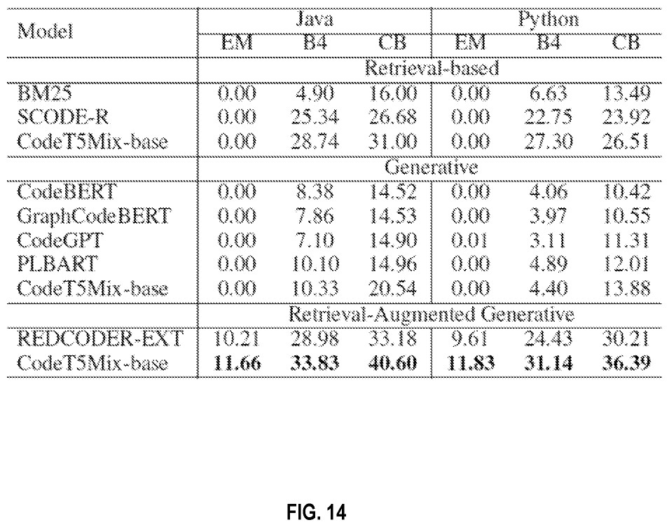

As shown in FIG. 14, CodeT5Mix achieves significantly better results in all categories, especially in the retrieval-based and RA generative setting shown in FIG. 5. Specifically, two code generation tasks by reversing the input and output order of code summarization on Java and Python and using their released deduplicated retrieval codebase. CodeT5Mix may be evaluated in three settings: retrieval-based, generative, and retrieval-augmented (RA) generative. For the retrieval-based setting, the bimodal encoder is activated to retrieve the top-1 code sample as the prediction given a text query, while for the RA generative setting, the combination of top-k retrieved samples (k=1 in this experiment) is appended to the input and activate the code generation decoder.

While the previous SoTA model REDCODER-EXT (Parvez et al., Retrieval augmented code generation and summarization, In proceedings of EMNLP (Findings), pp. 2719-2734, 2021) separately employs GraphCodeBERT as the retriever and PLBART as the generator, CodeT5Mix model can be flexibly used as an end-to-end system with both retrieval and generation capabilities.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for training an encoder-decoder based framework for code related tasks, the method comprising:
receiving, via a communication interface, a first training dataset of unimodal code data;
encoding, by an encoder, a first training input based on a first code sequence from the first training dataset into a first code representation;
generating, by a decoder, a code output from the first code representation;
computing at least one unimodal training objective based the code output and the first code sequence;
pretraining the encoder and the decoder according to the at least one unimodal training objective;
receiving, via a communication interface, a second training dataset of bimodal code-text pair data;
encoding, by the pretrained encoder, a second training input of a second code sequence and a text from the second training dataset into a second code representation and a text representation;
generating, by the pretrained decoder, a training output from the second code representation and the text representation;
computing at least one bimodal training objective based the training output and the second training input; and
training the pretrained encoder and the pretrained decoder according to the at least one bimodal training objective.

2. The method of claim 1, wherein the first training input is generated by randomly replacing a portion of tokens in the first code sequence into indexed sentinel tokens, and
wherein the at least one unimodal training objective is computed by comparing a reconstructed code sequence by the decoder with the first code sequence.

3. The method of claim 1, wherein the first training input is generated by:
randomly selecting a pivot location in the first code sequence; and
truncating a first portion of the first code sequence before the pivot location as the first training input; and
wherein the at least one unimodal training objective is computed by comparing a predicted remaining portion of code by the decoder with a second portion of the first code sequence after the pivot location.

4. The method of claim 1, wherein the at least one bimodal training objective is computed based on a batch of code-text pairs from the second training dataset by:
generating, by the encoder, a set of code representations and a set of text representations from the batch of code-text pairs;
computing a set of code-to-text similarities and a set of text-to-code similarities between the set of code representations and the set of text representations;
computing a contrastive loss by comparing the set of code-to-text similarities and the set of text-to-code similarities with ground-truth one-hot similarities.

5. The method of claim 1, wherein the at least one bimodal training objective is computed by:
generating, by a classification head of the decoder, a prediction on whether the second code sequence and the text is a matching pair; and
computing a matching loss by comparing the prediction and a ground-truth one-hot label corresponding to the second code sequence and the text.

6. The method of claim 1, wherein the at least one bimodal training objective is computed by:
generating, by the decoder, a predicted code sequence based on the text representation; and
computing a text-to-code loss by comparing the predicted code sequence and the second code sequence.

7. The method of claim 1, wherein the at least one bimodal training objective is computed by:
generating, by the decoder, a predicted text based on the second code representation; and
computing a code-to-text loss by comparing the predicted text and the text.

8. The method of claim 1, further comprising:
jointly training the pretrained encoder and the pretrained decoder according to a sum of multiple bimodal training objectives.

9. The method of claim 1, wherein the encoder comprises a first encoder module and a second encoder module that share same parameters and operate in parallel, and wherein the encoding the second training input comprises:
encoding, by the first encoder module, the text into the text representation; and
encoding, by the second encoder, the second code sequence into the second code representation in parallel.

10. The method of claim 1, wherein the decoder comprises one or more decoder modules that share same parameters except a last feed forward layer adapted as a different decoder head for different bimodal training objectives, and wherein the generating the training output comprises:
generating, by the one or more decoder modules, respective decoding outputs according to the different bimodal training objectives in parallel.

11. The method of claim 1, further comprising:
generating, by the trained encoder only, a code-related task output in response to a code-related task input according to a specific code-related task.

12. The method of claim 1, further comprising:
generating, by the trained decoder only, a code-related task output in response to a code-related task input according to a specific code-related task.

13. The method of claim 1, further comprising:
encoding, by the trained encoder, a code-related task input into a task representation; and
generating, by the trained decoder, a code-related task output from the task representation according to a specific code-related task.

14. A system for training an encoder-decoder based framework for code related tasks, the system comprising:
a memory that stores an encoder, a decoder and a plurality of processor executable instructions;
a communication interface that receives a first training dataset of unimodal code data and a second training dataset of bimodal code-text pair data; and
one or more hardware processors that read and execute the plurality of processor-executable instructions from the memory to perform operations comprising:
encoding, by the encoder, a first training input based on a first code sequence from the first training dataset into a first code representation;
generating, by the decoder, a code output from the first code representation;
computing at least one unimodal training objective based the code output and the first code sequence;
pretraining the encoder and the decoder according to the at least one unimodal training objective;
encoding, by the pretrained encoder, a second training input of a second code sequence and a text from the second training dataset into a second code representation and a text representation;
generating, by the pretrained decoder, a training output from the second code representation and the text representation;
computing at least one bimodal training objective based the training output and the second training input; and
training the pretrained encoder and the pretrained decoder according to the at least one bimodal training objective.

15. The system of claim 14, wherein the encoder comprises a first encoder module and a second encoder module that share same parameters and operate in parallel, and wherein the encoding the second training input comprises:
encoding, by the first encoder module, the text into the text representation; and
encoding, by the second encoder, the second code sequence into the second code representation in parallel.

16. The system of claim 14, wherein the decoder comprises one or more decoder modules that share same parameters except a last feed forward layer adapted as a different decoder head for different bimodal training objectives, and wherein the generating the training output comprises:
generating, by the one or more decoder modules, respective decoding outputs according to the different bimodal training objectives in parallel.

17. A non-transitory machine-readable medium comprising a plurality of machine-executable instructions which, when executed by one or more processors, are adapted to cause the one or more processors to perform operations comprising:
receiving, via a communication interface, a first training dataset of unimodal code data;
encoding, by an encoder, a first training input based on a first code sequence from the first training dataset into a first code representation;
generating, by a decoder, a code output from the first code representation;
computing at least one unimodal training objective based the code output and the first code sequence;
pretraining the encoder and the decoder according to the at least one unimodal training objective;
receiving, via a communication interface, a second training dataset of bimodal code-text pair data;
encoding, by the pretrained encoder, a second training input of a second code sequence and a text from the second training dataset into a second code representation and a text representation;
generating, by the pretrained decoder, a training output from the second code representation and the text representation;
computing at least one bimodal training objective based the training output and the second training input; and
training the pretrained encoder and the pretrained decoder according to the at least one bimodal training objective.

18. The non-transitory machine-readable medium of claim 17, wherein the encoder comprises a first encoder module and a second encoder module that share same parameters and operate in parallel, and wherein the encoding the second training input comprises:
encoding, by the first encoder module, the text into the text representation; and
encoding, by the second encoder, the second code sequence into the second code representation in parallel.

19. The non-transitory machine-readable medium of claim 17, wherein the decoder comprises one or more decoder modules that share same parameters except a last feed forward layer adapted as a different decoder head for different bimodal training objectives, and wherein the generating the training output comprises:
generating, by the one or more decoder modules, respective decoding outputs according to the different bimodal training objectives in parallel.

20. The non-transitory machine-readable medium of claim 17, wherein the operations further comprise:
generating by the trained encoder only, the trained decoder only, or both the trained encoder and decoder, a code-related task output in response to a code-related task input according to a specific code-related task.
